(19) United States
(12) Patent Application Publication
(10) Pub. No.: US 2020/0016976 A1
(43) Pub. Date: Jan. 16, 2020

(54) HIGH PRESSURE RESIN FUEL TANK WITH INTERNAL BRACKET SUPPORT STRUCTURE, FLEXIBLE UNION STRUCTURE, AND EXTERNAL STEEL PIPE REINFORCEMENT

(71) Applicant: HONDA MOTOR CO., LTD, Tokyo (JP)

(72) Inventors: Kevin J. KAASHOEK, Dublin, OH (US); Masaki WAKAO, Columbus, OH (US); Hiroshi KITAMURA, Dublin, OH (US)

(21) Appl. No.: 16/031,610

(22) Filed: Jul. 10, 2018

(51) Int. Cl. B60K 15/03; B60K 15/073

(52) U.S. Cl. CPC B60K 15/03177; B60K 15/073; B60K 2015/03467; B60K 2015/0346; B60K 2015/03493

(57) ABSTRACT

The present disclosure is directed to a fuel tank with internal support structures and external reinforcements to minimize deformations due to pressure variations, such as may arise from diurnal temperature variations. Uncontrolled contraction of fuel tanks may result in undesirable reductions of tank volume, and uncontrolled expansion of fuel tanks may result in unwanted collision of fuel tanks with other vehicle components. The fuel tank of the present disclosure may find utility in applications where regular venting of fuel tanks is not practical, such as in hybrid vehicles.

### BACKGROUND

The present disclosure is directed to a fuel tank made of a polymer resin material, as may be used in a hybrid vehicle. In hybrid vehicles, the fuel tank may not be used regularly, and as a result, the fuel tank may be subject to diurnal variations. As temperature rises during the daytime, fuel in the tank becomes pressurized (positive pressure), causing the tank wall to expand. This expansion may result in interaction of fuel tank walls with other vehicle components, which may be undesirable or unsafe. On the other hand, as temperature falls at night, the tank becomes de-pressurized (negative pressure), causing the tank wall to contract. This contraction may result in an undesirable reduction in tank volume and capacity. Accordingly, there is a need to minimize fuel tank expansion and contraction.

### SUMMARY

The following presents a simplified summary of one or more aspects of the present disclosure in order to provide a basic understanding of such aspects. This summary is not an extensive overview of all contemplated aspects and is intended to neither identify key or critical elements of all aspects nor delineate the scope of any or all aspects. Its purpose is to present some concepts of one or more aspects in a simplified form as a prelude to the more detailed description that is presented later.

In some embodiments, the present disclosure is directed to a fuel tank, comprising: a wall defining an interior space; a first support structure within the interior space and attached to the wall at a first location; a second support structure within the interior space and attached to the wall at a second location opposite the first location; a flexible union attaching the first support structure to the second support structure; and a third support structure abutting an exterior of the wall.

These and other aspects of the invention will become more fully understood upon a review of the detailed description, which follows.

### BRIEF DESCRIPTION OF THE DRAWINGS

FIG. 1A shows a schematic of a cross-sectional view of a fuel tank according to some aspects of the present disclosure.

FIG. 1B shows the fuel tank of FIG. 1A with a flexible union according to some aspects of the present disclosure. FIG. 1C shows a cross-sectional view along the line A-A′ shown in FIG. 1B.

FIG. 1D shows the fuel tank of FIG. 1A with a flexible union according to other aspects of the present disclosure. FIG. 1E shows a zoomed-in view of a portion of FIG. 1D.

FIG. 1F shows the fuel tank of FIG. 1A under negative pressure.

FIG. 1G shows the fuel tank of FIG. 1A under positive pressure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details.

The present disclosure is directed to a fuel tank with an internal support structure and an external reinforcement structure to minimize deformations in the tank walls arising from pressure variations, such as may result from, e.g., diurnal temperature variations. When the tank is under positive pressure (e.g., when the fuel contained within is at high pressure, such as at high temperature), expansion of the tank is limited by the external reinforcement structure. When the tank is under negative pressure (e.g., when the fuel contained within is at low pressure, such as at low temperature), contraction of the tank is limited by the internal support structure. Such fuel tanks may find utility in applications where regular venting of the fuel tank is not practical, for example, in hybrid vehicles.

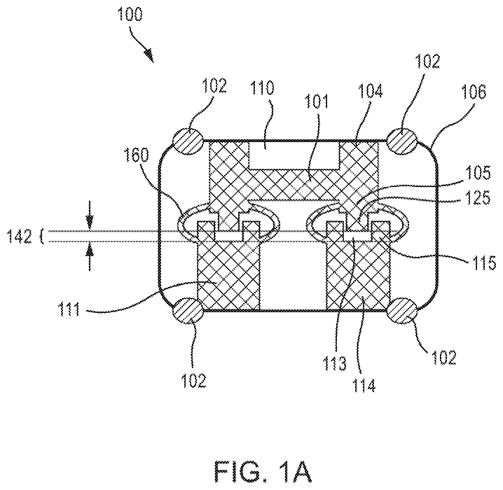

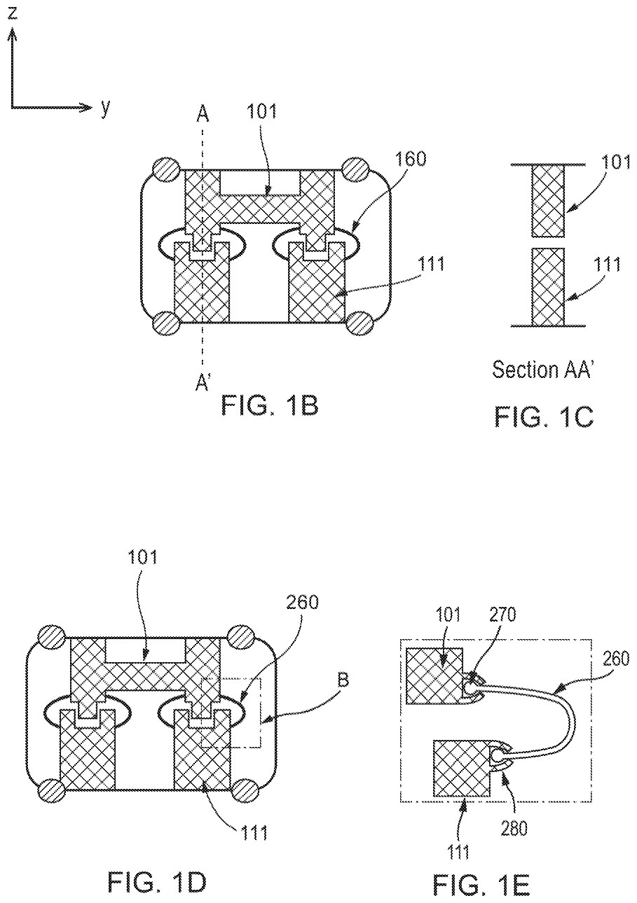

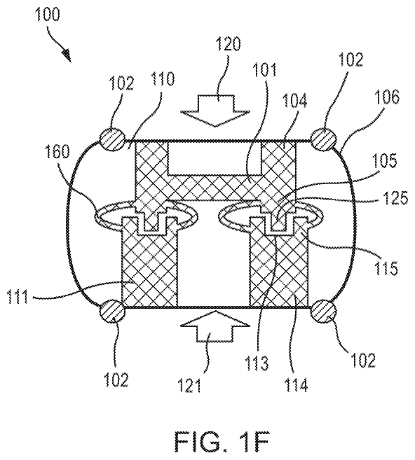

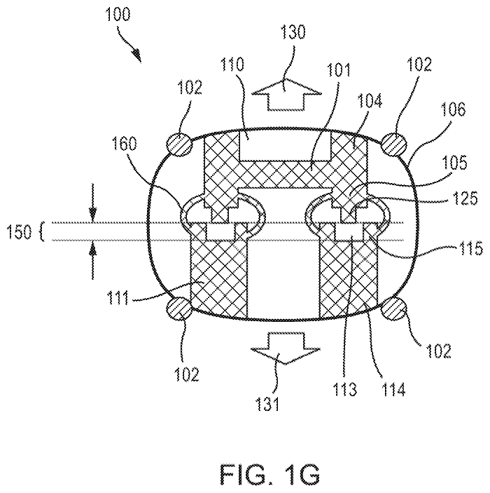

FIG. 1A shows a cross-sectional view of a fuel tank 100, at neutral pressure, having a wall 106 defining an internal space 110. When tank 100 is in use, internal space 110 is configured to contain a liquid or a gas, such as a fuel (not shown). Fuel tank 100 also contains, within internal space 110, a first support structure 101, a second support structure 111, and a flexible union 160 attaching first support structure 101 to second support structure 111. First support structure 101 is attached to wall 106 at one or more first ends 104 at a respective first position. First support structure 101 also contains one or more second ends 105 distal to the first position, and the one or more second ends 105 each contains a respective projection 125 therefrom. Similarly to first support structure 101, second support structure 111 is attached to wall 106 at one or more first ends 114, at a respective second position opposite the first position. The second support structure 111 also contains one or more second ends 115 distal to the second position, and recess 113 is contained within second end 115. In the aspect shown, projection 125 and recess 113 face each other in an “end-on” direction. Wall 106 is also surrounded by a third support structure, external reinforcements 102.

The one or more first ends 104 of first support structure 101, and the one or more first ends 114 of second support structure 111, may be attached to wall 106 by any suitable means known to those of ordinary skill in the art in order to keep first support structure 101 and second support structure 111 attached to wall 106 during fueling, storage, and use of tank 100. Suitable means include, but are not limited to, welding, or a snap-fit. In a non-limiting example, the one or more first ends 104 of first support structure 101 and the one or more first ends 114 of second support structure 111 are attached to wall 106 by welding.

Recess 113 is positioned so as to receive projection 125. Recess 113 and projection 125 may each be of any size or shape, so long as recess 113 is complementary to projection 125. Recess 113 is preferably sized relative to projection 125 so as to minimize lateral (not end-on) movement of projection 125 within recess 113.

Wall 106, first support structure 101, and second support structure 111 may be made of any materials capable of withstanding temperature and pressure variations during manufacture, assembly, and use of tank 100 and that do not react with liquids of gases which may fill the internal space 110. Suitable materials include, but are not limited to, polymer resins such as high-density polyethylene (HDPE), polypropylene, nylon, isoprene, and polyurethane. Wall 106 may consist of one or more layers, such as an inner layer and an outer layer. In some such aspects, the inner layer may be HDPE. First support structure 101 and second support structure 111 may be made of the same or different materials than wall 106. In addition, first support structure 101 and second support structure 111 may be a different thickness than wall 106. For example, first support structure 101 and second support structure 11 may be thinner than wall 106 or thinner than an inner layer of wall 106. Wall 106, first support structure 101, and second support structure 111 may be manufactured by any suitable means known to those of ordinary skill in the art, including, but not limited to, blow molding, injection molding, casting, etc.

Flexible union 160 may be made of any materials capable of withstanding temperature and pressure variations during manufacture, assembly, and use of tank 100 and that do not react with liquids or gases which may fill the internal space 110. However, flexible union 160 is preferably made of a more flexible and/or less rigid material than first support structure 101, second support structure 111, or wall 106, or flexible union 160 is shaped or otherwise configured to make flexible union 160 more flexible than first support structure 101 or second support structure 111. Suitable materials for flexible union 160 include, but are not limited to, polymer resins such as high-density polyethylene (HDPE), polypropylene, nylon, isoprene, and polyurethane.

Flexible union 160 may be attached to first support structure 101 and second support structure 111 by any suitable means known to those of ordinary skill in the art, including, but not limited to, screws, nuts and bolts, fasteners, welding, or a snap-fit. In one non-limiting example, flexible union 160 is attached to first support structure 101 and second support structure 111 by snap-fits.

In one non-limiting example, flexible union 160 is attached to first support structure 101 and second support structure 111 as shown in FIG. 1B. The flexible union 160 in FIG. 1B is a thinner section of the same material as is used for first support structure 101 and second support structure 111. Such a flexible union 160 may be formed by the same methods as first support structure 101 and second support structure 111, such a flexible union 160 occurs on either side of first support structure 101 and second support structure 111 as shown in FIG. 1B. In some aspects, the combination of first support structure 101, second support structure 111, and flexible unions 160 may be produced as one piece. FIG. 1C shows a sectional view along line A-A′ when viewed along the y-axis.

In another non-limiting example, flexible union 260 is attached to first support structure 101 and second support structure 111 as shown in FIG. 1D. Flexible union 260 is similar in some aspects to flexible union 160. Flexible union 260 may be made of the same or different material than first support structure 101 and second support structure 111. Flexible union 260 may be secured to first support structure 101 and second support structure 111 via a ball and socket joint, as shown in box B. FIG. 1E shows a zoomed-in view of box B, where ball 270 is held in socket 280. Socket 280 may be secured to first support structure 101 and second support structure 111 via snap-fit, screws, nuts and bolts, fasteners, or welding.

When tank 100 is under negative pressure, i.e., wall 106 has a tendency to contract in directions 120, 121, contraction is limited by first support structure 101 and second support structure 111. As shown in FIG. 1F, first support structure 101 can be welded at one or more first ends 104 to wall 106 such that, when tank 100 is under negative pressure, the respective projections 125 at second ends 105 are received in the respective recesses 113 in second ends 115 of second support structure 111. In the aspect shown, first support structure 101 has an H-shape with two second ends 105, each with a respective projection 125, which is received into a recess 113 in a second end 115 of each of two second support structures 111. Although first support structure 101 is depicted as having an H-shape, first support structure 101 may have any suitable shape. In addition, although each recess 113 may be larger than the corresponding projection 125, the recess 113 and projection 125 are sized to minimize movement of projection 125 within recess 113, thus limiting collapsibility of tank 100. In addition, the resting gap 142 existing at neutral pressure (FIG. 1A) is eliminated under negative pressure. Lastly, the one or more external reinforcements 102 may serve to limit or direct regional bulging of wall 106 upon overall contraction of tank 100.

When tank 100 is under positive pressure, i.e., wall 106 has a tendency to expand in directions 130 and 131, expansion is limited by the one or more external reinforcements 102 and the flexible union 160. As shown in FIG. 10, wall 106 bulges outward in directions 130 and 131, but the bulging is blocked by the one or more external reinforcements 102. In addition, flexible union 160 expands to create an expanded gap 150 vertically between projection 125 and recess 113. Expanded gap 150 is larger than resting gap 142 and is limited in size by the length and flexibility of flexible union 160 and the one or more external reinforcements 102. The one or more external reinforcements 102 may be made of any material capable of withstanding the faces of expansion upon wall 106 as also modulated by flexible union 160. Suitable materials for the one or more external reinforcements 102 include, but are not limited to, steel or stainless steel, such as steel piping or stainless steel piping, STAM steel grade, aluminum, or fiber-reinforced plastic. The material is suitably selected based on the allowable deformation desired in the tank wall, which can be determined by those of ordinary skill in the art. In addition, the welds attaching first support structure 101 and second support structure 111 to wall 106 are not under stress when tank 100 is under positive pressure.

As will be known to those of ordinary skill in the art, ranges of pressure variation for tank 100 will depend on several factors, including, but not limited to, tank dimensions, temperature variations, climate, vehicle, and frequency and conditions of use (of the vehicle or more specifically of the fuel tank, such as in the case of a hybrid vehicle). Determination these factors and of pressure variation ranges is within the level of ordinary skill in the art. The pressures are higher in magnitude in both the positive and negative directions than conventional fuel tanks.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. Aspects from the various embodiments described, as well as other known equivalents for each such aspect, can be mixed and matched by one of ordinary skill in the art to construct additional embodiments and techniques in accordance with principles of this application.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the disclosure. Therefore, the disclosure is intended to embrace all known or later-developed alternatives, modifications, variations, improvements, and/or substantial equivalents.

Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Further, the word “example” is used herein to mean “serving as an example, instance, or illustration.” Any aspect described herein as “example” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B. or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. Nothing disclosed herein is intended to be dedicated to the public regardless of whether such disclosure is explicitly recited in the claims.

The examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g. amounts, dimensions, etc.) but some experimental errors and deviations should be accounted for.

Moreover, all references throughout this application, for example patent documents including issued or granted patents or equivalents; patent application publications; and non-patent literature documents or other source material; are hereby incorporated by reference herein in their entireties, as though individually incorporated by reference.

What is claimed is:

1. A fuel tank, comprising:
a wall defining an interior space;
a first support structure within the interior space and attached to the wall at a first location;
a second support structure within the interior space and attached to the wall at a second location opposite the first location;
a flexible union attaching the first support structure to the second support structure; and
a third support structure abutting an exterior of the wall.

2. The fuel tank of claim 1, wherein the third support structure is positioned so as to limit expansion of the wall of the fuel tank when the fuel tank is under a positive pressure.

3. The fuel tank of claim 2, wherein the third support structure comprises one or more steel pipes surrounding the wall.

4. The fuel tank of claim 1, wherein:
the first support structure is characterized by
a first end attached to the wall at the first location, and
a second end distal to the first end containing a projection;
the second support structure is characterized by
a first end attached to the wall at the second location, and
a second end distal to the first end containing a recess; and
the recess is configured to receive the projection.

5. The fuel tank of claim 4, wherein the flexible union attaches the second end of the first support structure to the second end of the second support structure.

6. The fuel tank of claim 1, wherein the first support structure and the second support structure are comprised of a polymer resin material.

7. The fuel tank of claim 6, wherein the polymer resin material is high-density polyethylene (HDPE).

8. The fuel tank of claim 1, wherein the wall comprises at least an inner layer and an outer layer, and at least the inner layer is comprised of a polymer resin material.

9. The fuel tank of claim 8, wherein the polymer resin material is high-density polyethylene (HDPE).

10. The fuel tank of claim 9, wherein the first support structure and the second support structure are comprised of a polymer resin material.

11. The fuel tank of claim 10, wherein the polymer resin material is HDPE.

12. The fuel tank of claim 1, wherein the flexible union is comprised of a polymeric material.
